(19) United States
(12) Patent Application Publication
(10) Pub. No.: US 2008/0277558 A1
(43) Pub. Date: Nov. 13, 2008

(54) Adjustable Support Device

(76) Inventors: Christopher J. Litwin, Stamford, CT (US); Cleveland A. Christophe, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/055,886

(22) Filed: Mar. 26, 2008

Related U.S. Application Data
(60) Provisional application No. 60/927,948, filed on May 7, 2007.

(51) Int. Cl. A47G 29/00; B65D 25/28; F16M 9/00

(52) U.S. Cl. 248/637; 248/694; 16/110.1

(57) ABSTRACT

An adjustable support device is disclosed generally comprising a support post having an internal channel an arm slidable within the internal channel. The arm is generally shaped such that, gravitational bias of the arm under the influence of its own weight will cause the arm to lock within the internal channel. In certain embodiments, the arm is pivotable within the internal channel. The arm is freely slidable within the internal channel when the arm is pivoted so that it is substantially perpendicular to the support post, and locks within the internal channel when it is pivoted so that it is not substantially perpendicular to the support post. In further embodiments, the support device is used in connection with a conventional turkey deep-fryer.

### CROSS-REFERENCE TO RELATED APPLICATIONS

This application claims priority benefits under 35 § U.S.C. 119(e) of the U.S. Provisional Application No. 60/927,948 filed on May 7, 2007.

### FIELD OF THE INVENTION

The present invention relates generally to a support device, and more specifically to a support device having an adjustable arm designed to support a load in a fixed position when acted upon by the force of gravity.

### BACKGROUND OF THE INVENTION

The deep-fried turkey has considerably grown in popularity in recent years. The apparatus for frying the turkey or other food item generally consists of a kettle for containing the oil, a supporting stand for holding the kettle, a basket or rack for mounting the turkey, and a burner. Several examples of this apparatus are disclosed in U.S. Pat. No. 7,044,049 to Johnston; U.S. Pat. No. 6,941,857 to McLemore; U.S. Pat. No. 6,711,992 to McLemore; and U.S. Pat. No. 5,813,321 to Bourgeois.

While these deep-fryers are simple in design and generally easy to use, they harbor potentially destructive and life-threatening consequences. With a conventional turkey-fryer, the user mounts a turkey on a rack and manually lowers this rack into a kettle of oil heated by a burner. In the current state of the art, there is no mechanism for preventing the turkey from falling rapidly into the kettle of hot oil if the user suddenly releases the turkey. This can cause hot oil to splash outside of the kettle where it can come into contact with the open flame of the burner and cause a grease fire. These grease fires are difficult to extinguish and can cause severe personal injury and significant property damage if the deep-fryer is used in or in close proximity to one's home.

Additionally, once the turkey has finished frying, it is preferable to allow any excess oil remaining on or in the turkey to drain off before consumption. Currently, the user must manually hold the turkey over the kettle while the oil drains from the turkey which can be a time consuming and physically arduous task.

One example of a device that attempts to address these problems is disclosed in U.S. Patent Application Pub. No. US 2006/0144246/A1 to Holliday. The Holliday patent relates to a portable utility stand for supporting and suspending the inner basket of a fryer and its contents, such as a turkey, over a cooking vessel. The utility stand comprises a wide base assembly, a vertical support assembly, and a hanger assembly with a main hook. The vertical support assembly comprises a vertical extension that fits telescopingly into the vertical support member.

One disadvantage of this device, however, is that there are multiple assemblies and parts, each connected together with fasteners, which must be adjusted in order to lower a turkey into the cooking vessel. The height of the vertical support assembly can only adjusted by manually raising or lowering the vertical extension and securing it to the vertical support member in the desired position by a detent or thumb wheel. Furthermore, the position of the hanger assembly itself is difficult to adjust. In one embodiment, the user positions the hanger assembly by inserting a retainer into a fixed slot located on the vertical support member. In another embodiment, the hanger assembly is mounted on expanded band, which fits telescopingly around the vertical support assembly and is secured by means of a detent or thumb wheel.

In either embodiment of this invention, lowering the inner basket into the cooking vessel involves several steps and requires the user to release/tighten a particular fastening means and often to adjust the structure of the utility stand itself. This can be a cumbersome task, particularly if there is a turkey or some other food item in the basket. Furthermore, if the user drops the basket during adjustment, there is no restraint that would prevent the turkey from rapidly falling into the kettle of hot oil.

What is desired, therefore, is a support device that allows a user to smoothly and securely lower a turkey or other food item into the kettle of a conventional turkey-fryer without having to adjust any fasteners or the structure of the device itself. It is also desired to have a support device that will automatically prevent a turkey from falling into the kettle if the user prematurely releases the basket or rack. It is further desired to have a support device that provides a means for suspending the turkey above the fryer so that excess oil may drain once frying is done.

Additionally, adjustable support devices known in the storage, shelving, and hardware industries suffer from similar downfalls as the utility stand disclosed by Holliday. Thus, what is desired is a simple and adjustable, yet secure support device that can be used in a variety of applications.

### SUMMARY OF THE INVENTION

Accordingly, it is an object of the present invention to provide a secure, yet adjustable device for supporting a load without the use of fasteners.

It is a further object of the present invention to provide a versatile support device that may be used in several configurations and has applications in many different fields of art.

It is a further object of the present invention to provide a device for supporting a load that will automatically hold the load in a fixed position when acted upon by gravity.

It is yet a further object of the present invention to provide a device for supporting a turkey or other food item above a conventional turkey fryer that provides the ability to safely lower the turkey into the fryer.

It is a further object of the present invention to provide a device for supporting a turkey or other food item above a conventional turkey fryer that will automatically prevent it from falling into the hot oil if a user releases the weight of the turkey.

In order to overcome the deficiencies of the prior art and to achieve at least some of the objects and advantages listed, the invention comprises a support post having an internal channel and an arm slidable within said internal channel, the arm being shaped such that, gravitational bias of said arm under the influence of its own weight causes said arm to lock within the internal channel. In one embodiment, the arm is pivotable within the internal channel. The arm may be freely slidable within the internal channel when the arm is pivoted so that it is substantially perpendicular to the support post. Also, the arm may lock within the internal channel when the arm is pivoted so that it is not substantially perpendicular to the support post. The internal channel may have a rear surface and at least one forward surface and the arm may comprise a head portion having a rear surface and a forward surface, and may be shaped to be slidably received within the internal channel. The rear surface and the forward surface of the head portion may be arranged such that, when the arm is pivoted so that it is not substantially perpendicular to the support post, the rear surface of the head portion engages the rear surface of the internal channel and the forward surface of the head portion engages the at least one forward surface of the internal channel.

In another embodiment, the at least one forward surface of the internal channel may comprise a first forward surface and a second forward surface. The rear surface and the forward surface of the head portion may be arranged such that, when the arm is pivoted so that it is not substantially perpendicular to the support post, the rear surface of the head portion may engage the rear surface of the internal channel and the forward surface of the head portion may engage the first forward surface and the second forward surface of the internal channel.

The support device may further comprise a tooth located on the rear surface of the head portion and a plurality of grooves on the rear surface of said internal channel shaped to accept the tooth. The arm may further comprise a body portion positioned adjacent to said head portion. In one embodiment, the body portion may comprise a handle. A connecting member may also be provided at an end of the handle remote from the support member. The connecting member may be a hook.

In addition, the support post may further include at least one notch shaped to accept the rim of a deep-fryer kettle. A strap and a latch for securing the support device around a kettle may also be provided. The strap may be connected to the support post. The support post may also include a stopping mechanism within the internal channel to prevent the head portion from advancing past. This stopping mechanism may be a pin.

In yet another embodiment, the support device may further include a splash guard. The splash guard may be a substantially circular member having an opening to accept the connecting member. The splash guard may also be two substantially domed portions connected together on a side by a hinge and may also have an opening to accept the connecting member. Alternatively, the splash guard may also be a substantially cone-shaped collar being open on a side.

The objects of the present invention are further met by providing a support device comprising a support post having an internal channel including a rear surface and at least one forward surface, and an arm comprising a body portion and a head portion, the head portion having a rear surface and a forward surface and being shaped to be slidably received within the internal channel of the support post. The rear surface of the head portion may be arranged such that, gravitational bias of the arm under the influence of its own weight causes the rear surface of the head portion to engage the rear surface of the internal channel and the forward surface of the head portion to engage the at least one forward surface of the internal channel.

The at least one forward surface of the internal channel may comprise a first forward surface and a second forward surface. The rear surface and the forward surface of the head portion may be arranged such that, gravitational bias of the arm under influence of its own weight causes the rear surface of the head portion to engage the rear surface of the internal channel and the forward surface of the head portion to engage the first forward surface and the second forward surface of the internal channel.

In addition, the body portion may comprise a handle. The handle may also include a connecting member, which may be provided as a hook, at an end remote from the support member. The support post may further include a notch. The support device may further comprise a strap with a latch, which may be connected to the support post. The support post may also include a stopping mechanism within the internal channel to prevent the head portion from advancing past. This stopping mechanism may be a pin.

In yet another embodiment, the support device may further include a splash guard. The splash guard may be a substantially circular member having an opening to accept the connecting member. The splash guard may also be two substantially domed portions connected together on a side by a hinge and may also have an opening to accept the connecting member. Alternatively, the splash guard may also be a substantially cone-shaped collar being open on a side.

The objects of the present invention may further be met by providing a turkey deep-fryer comprising a support post having an internal channel and an arm slidable within the internal channel of the support post, a kettle, and a turkey mounting apparatus. The mounting apparatus may be a rack, or alternatively, a basket. The arm may be shaped such that, gravitational bias of the arm under the influence of its own weight causes the arm to lock within the internal channel. The internal channel may also comprise a rear surface and at least one forward surface and the arm may comprise a body portion and a head portion, the head portion having a rear surface and a forward surface. The rear surface and the forward surface of the head portion may be arranged such that, gravitational bias of the arm under the influence of its own weight causes the rear surface of the head portion to engage the rear surface of the internal channel and the forward surface of the head portion to engage the at least one forward surface of the internal channel.

In another embodiment, the at least one forward surface of the internal channel may comprise a first forward surface and a second forward surface. The rear surface and the forward surface of the head portion may be arranged such that, gravitational bias of the arm under the influence of its own weight causes the rear surface of the head portion to engage the rear surface of the internal channel and the forward surface of the head portion to engage the first forward surface and the second forward surface of the internal channel.

In addition, the handle may have a connecting member at an end remote from the support member for connecting the handle to the turkey mounting apparatus. The connecting member may be a hook. The kettle may have a rim and the support post may further include at least one notch shaped to accept the rim. A strap and a latch for securing the support device around a kettle may also be provided. The strap may be connected to the support post. The support post may also include a stopping mechanism within the internal channel to prevent the head portion from advancing past. This stopping mechanism may be a pin.

In yet another embodiment, the support device may further include a splash guard. The splash guard may be a substantially circular member having an opening to accept the connecting member. The splash guard may also be two substantially domed portions connected together on a side by a hinge and may also have an opening to accept the connecting member. Alternatively, the splash guard may also be a substantially cone-shaped collar being open on a side.

### BRIEF DESCRIPTION OF THE DRAWINGS

FIG. 1 is a perspective view of the support device showing the arm disposed within the internal channel of the support post.

FIG. 2(a) is a front view of the support post of the support device of FIG. 1.

FIG. 2(b) is a side view of the support post of the support device of FIG. 1.

FIG. 2(c) is a perspective view of the support post of the support device of FIG. 1.

FIG. 2(d) is a top view of the support post of the support device of FIG. 1.

FIG. 3(a) is a front view of the arm of the support device of FIG. 1.

FIG. 3(b) is a side view of the arm of the support device of FIG. 1.

FIG. 3(c) is a top view of the arm of the support device of FIG. 1.

FIG. 4 shows the support device of FIG. 1 in operation, including both the “locked” and “unlocked” positions of the arm.

FIG. 5(a) is a front view of the support post of the support device of FIG. 1 with a plurality of grooves.

FIG. 5(b) is a perspective view of the tooth.

FIG. 5(c) is a perspective view of the tooth on the head portion of the arm.

FIG. 5(d) is a side view of the arm and support post showing the tooth engaging a groove in operation.

FIGS. 6 and 7 are perspective views of the support device of FIG. 1, as used in connection with a turkey fryer.

FIG. 8 is a perspective view of a dome splash guard that may be used in conjunction with the support device and turkey fryer of FIGS. 6 and 7.

FIG. 9 is a perspective view of a disc splash guard and a collar splash guard that may be used in conjunction with the support device and turkey fryer of FIGS. 6 and 7.

FIG. 10 is a side view of an additional embodiment of the support device.

### DETAILED DESCRIPTION OF THE INVENTION

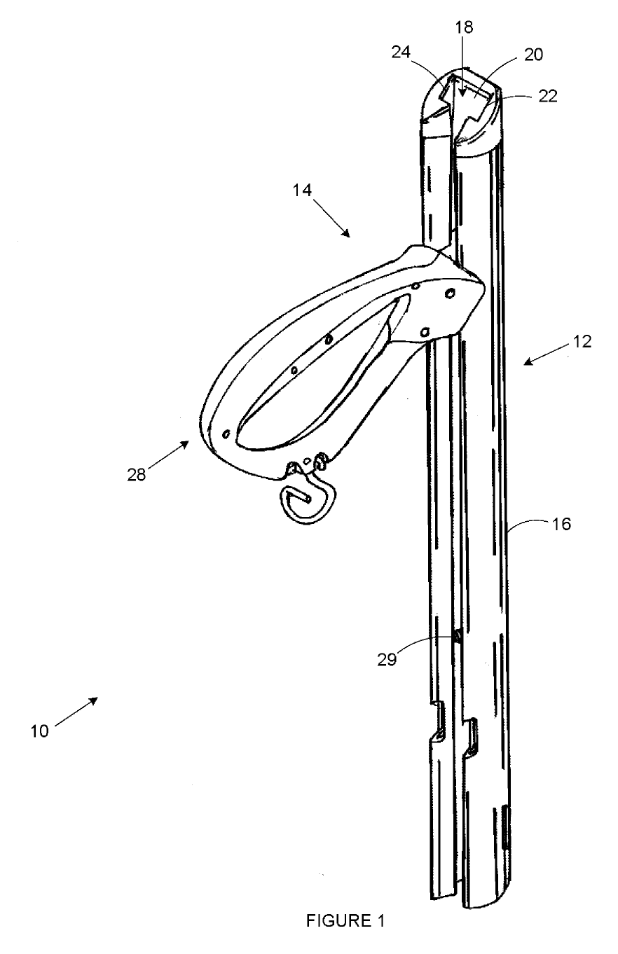

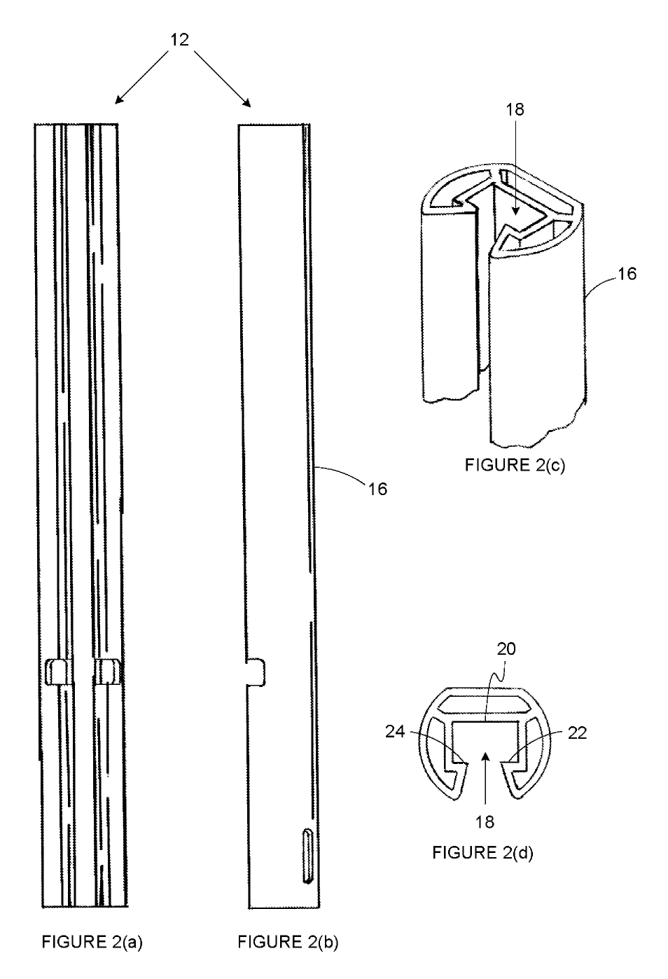

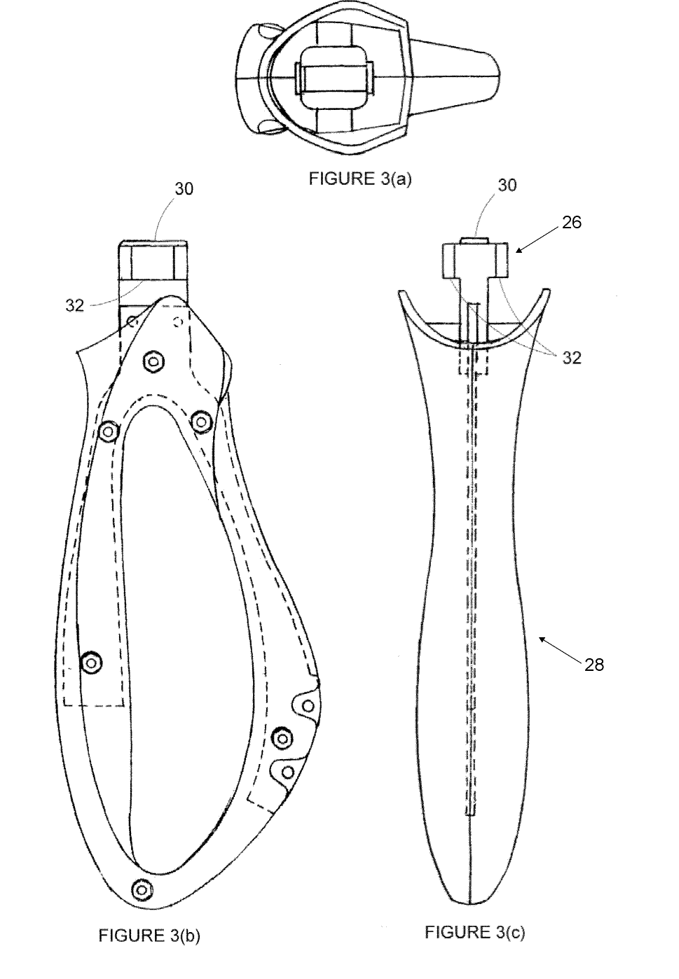

The basic components of one embodiment of a support device in accordance with the present invention are illustrated in FIGS. 1-3. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

Referring now to FIGS. 1-3(a)-(c), a support device 10 comprises a support post 12 and an arm 14. The support post 12 includes a housing 16 and an internal channel 18 having a rear surface 20, first forward surface 22, and second forward surface 24. The arm 14 has a head portion 26 and a body portion 28. The head portion 26 has a rear surface 30 and a forward surface 32 and is shaped to be slidably received within the internal channel 18.

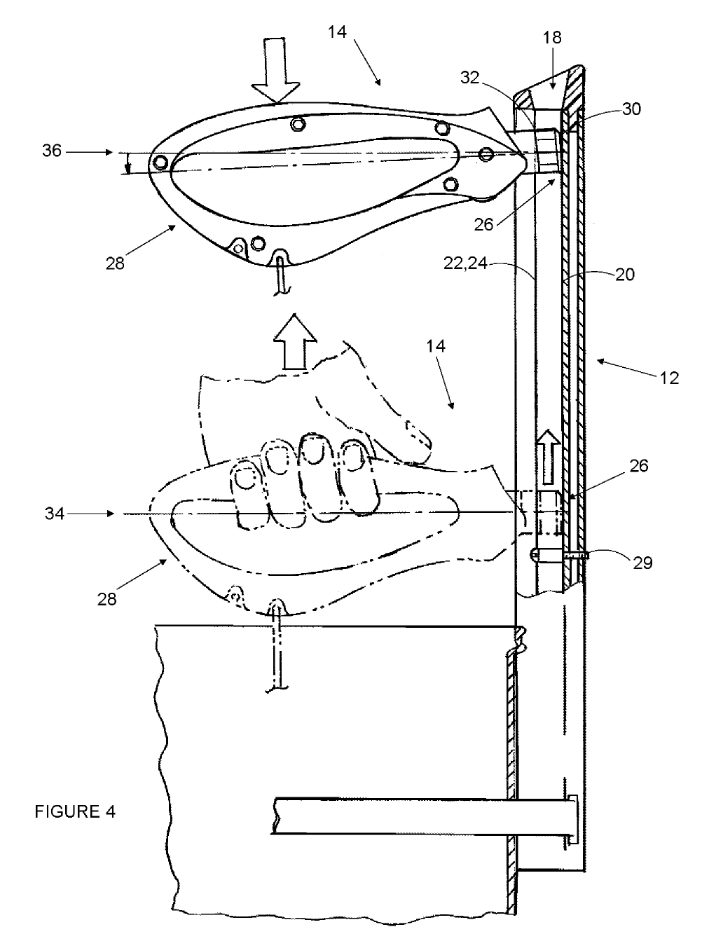

In operation, as shown in FIG. 4, when the arm 14 is held so that it is substantially perpendicular to the support post 12, the head portion 26 is easily slidable within the internal channel 18. In this “unlocked” position 34, a user may either reposition the arm 14 along the length of the support post 12, or remove the head portion 26 from the internal channel 18 altogether. However, when arm 14 is biased so that it is not substantially perpendicular to the support post 12 the rear surface of the head portion 30 will engage the rear surface of the internal channel 20 and the forward surface of the head portion 32 will engage the first forward surface 22 and the second forward surface 24 of the internal channel 18. Due to the force of gravity acting on the arm, the arm 14 will automatically bias and “lock” 36 within the internal channel when it is released by the user.

In this “locked” position 36, the force of friction acting on the head portion 32 and the internal channel 20 prevents the arm 14 from sliding within the channel 20. Therefore, it is preferable to construct the head portion 32 and the internal channel 20 from materials having a coefficient of friction that allows the arm 14 to support a load in a fixed position. For example, materials such as aluminum or high-density plastic or rubber may be used. Depending on the desired use of the support device 10, materials providing higher coefficients of friction may be used to provide greater load-bearing capabilities.

The support device 10 may also be provided with a pin 29 along the length of the internal channel 20. The pin 29 provides a means for preventing the handle from advancing past the desired position.

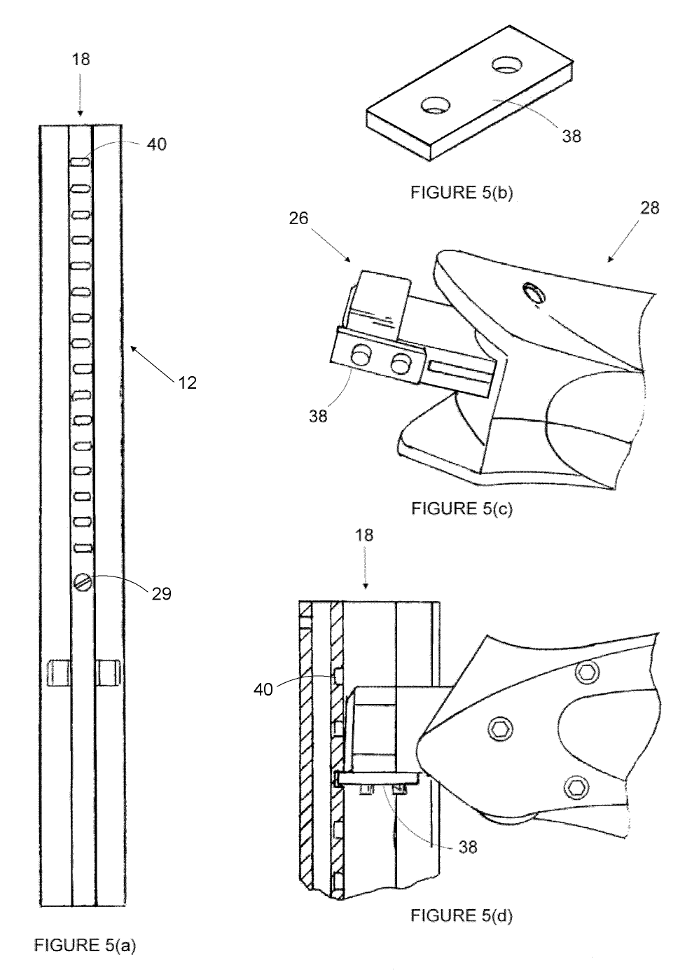

In another embodiment, as shown in FIGS. 5(a)-(d), the support means is equipped with a tooth 38 on the head portion 26 and the rear surface of the internal channel is equipped with a plurality of grooves 40 shaped to accept the tooth 38. When the tooth 38 mates with a groove 40, the arm 14 is able to support a greater load. Again, when the arm 14 is held substantially perpendicular to the support post 12, the tooth 38 will not mate with a groove 40 and the head portion 26 will be slidable within the internal channel 18.

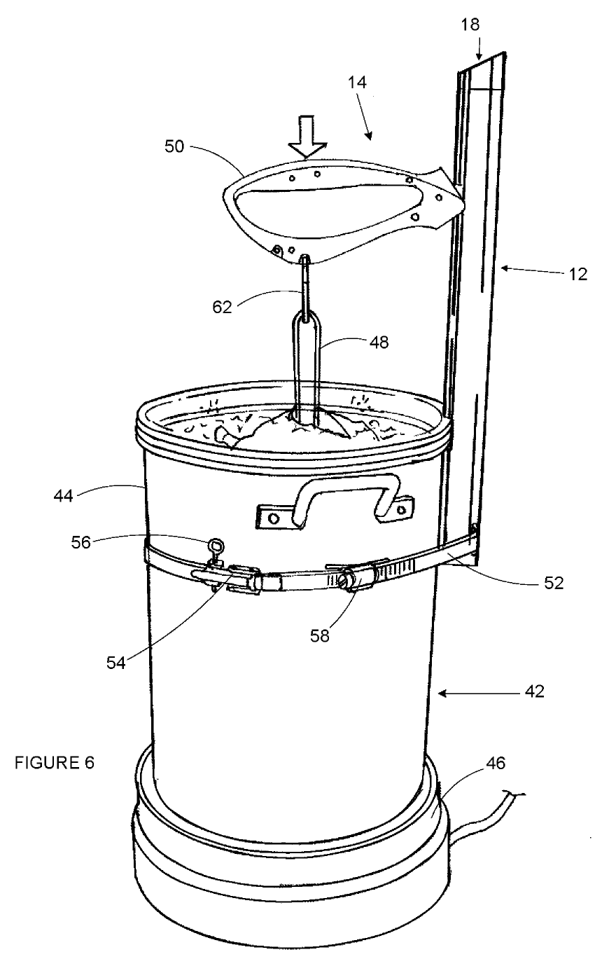

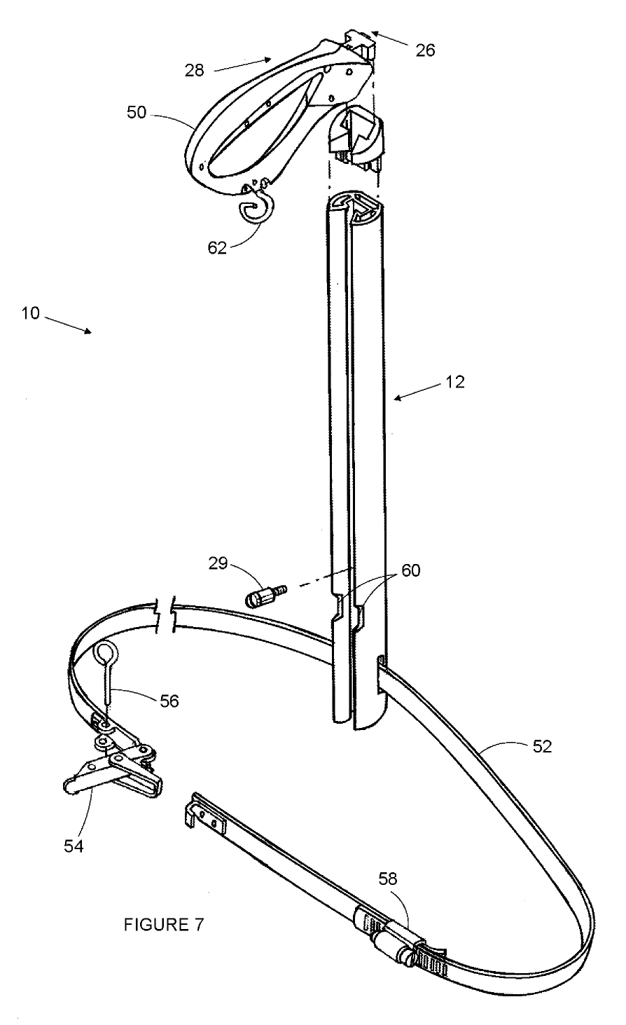

As shown in FIGS. 6 and 7, the support device 10 may be used in conjunction with a conventional turkey fryer 42. The fryer consists of a kettle 44 for containing the oil, a supporting stand 46 for holding the kettle, a basket or rack 48 for mounting a turkey, and a burner (not shown). In this embodiment, the body portion 28 is provided as a handle 50 for a user to grasp. Preferably, the handle 50 is made from a heat resistant material. The support device 10 further comprises a strap 52 for securing the support device to a kettle 44. The strap 52 closes around the kettle with a latch 54, which may include a pin 56 to keep it closed. Additionally, the strap 52 may be provided with an adjustment means 58 to allow a user to adjust the length of the strap to fit kettles of various sizes. The support post 12 is also provided with at least one notch 60 shaped to accept the rim of the kettle to prevent the support device 10 from sliding down once a load (such as a turkey) is placed upon the arm. Additionally, the handle is provided with a connecting member 62, shown as a hook, for holding the rack 48. In this embodiment, the pin 29 is preferably located at a position along the internal channel 20 so that when the arm 14 is lowered to that position, the rack 48 does not touch the bottom of the kettle.

In operation, a user first aligns the support post 12 so that the notch 60 is fitted on the rim of the kettle 44 and then tightens the strap 52 around the kettle to secure the device 10 in place. The user then removes the handle 50 from the support post 12, hangs the rack 48 bearing a turkey or other food item from the hook 62, and reinserts the head portion 32 into the internal channel 20 at the top of the post. Then the user grasps the handle 50, lifts the weight of the turkey, and unlocks the arm 14 by holding it substantially perpendicular to the support post 12. At this point, the user may slowly lower the turkey into the kettle filled with hot oil. If the user were to suddenly release the handle before the basket or rack reached the bottom of the kettle, the weight of the turkey on the handle would bias the head portion 26 within the internal channel 18 and lock the arm into place. Once frying is complete, the user again lifts the weight of the turkey to unlock the arm and slides it up the support post so that the turkey is completely out of the oil. Upon releasing the handle, the arm will lock into place under the weight of the turkey and the excess oil may drain back into the kettle.

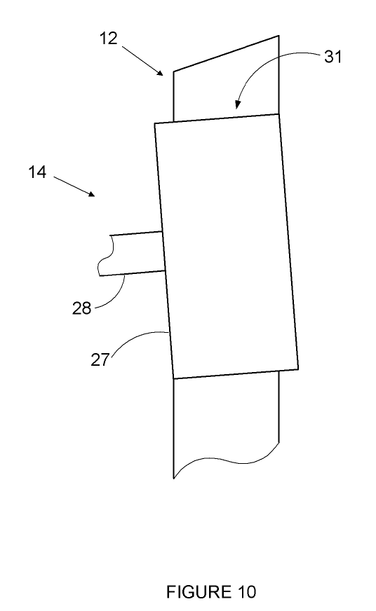

Referring to FIG. 10, an additional embodiment of the support device may also comprise a support post 12 and an arm 14. The arm 14 has a sleeve portion 27 and a body portion 28. The sleeve portion 27 is slidably received around the support post 12 and has at least one internal surface 31. In operation, when the arm 14 is held so that it is substantially perpendicular to the support post 12, the sieve portion 27 is easily slidable along the support post 12. In this “unlocked” position, a user may either reposition the arm 14 along the length of the support post 12, or remove the sleeve portion 27 from the support post 12 altogether. However, when arm 14 is biased so that it is not substantially perpendicular to the support post 12, the at least one internal surface of the sleeve portion 31 will engage the support post 12 and “lock” into a fixed position. Due to the force of gravity acting on the arm, the arm 14 will automatically bias against the support post 12 when it is released by the user.

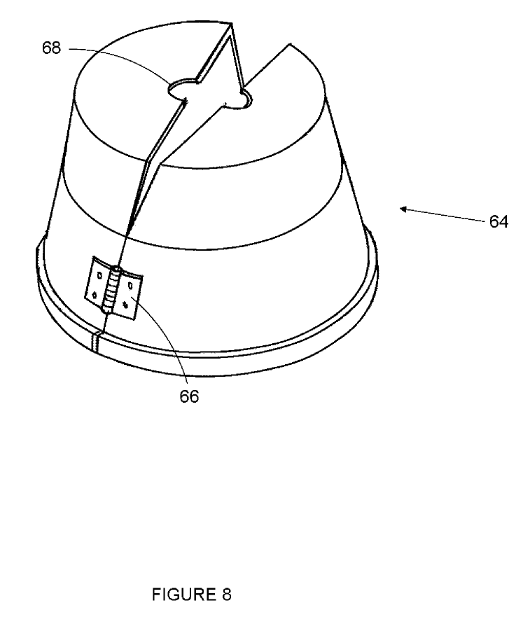

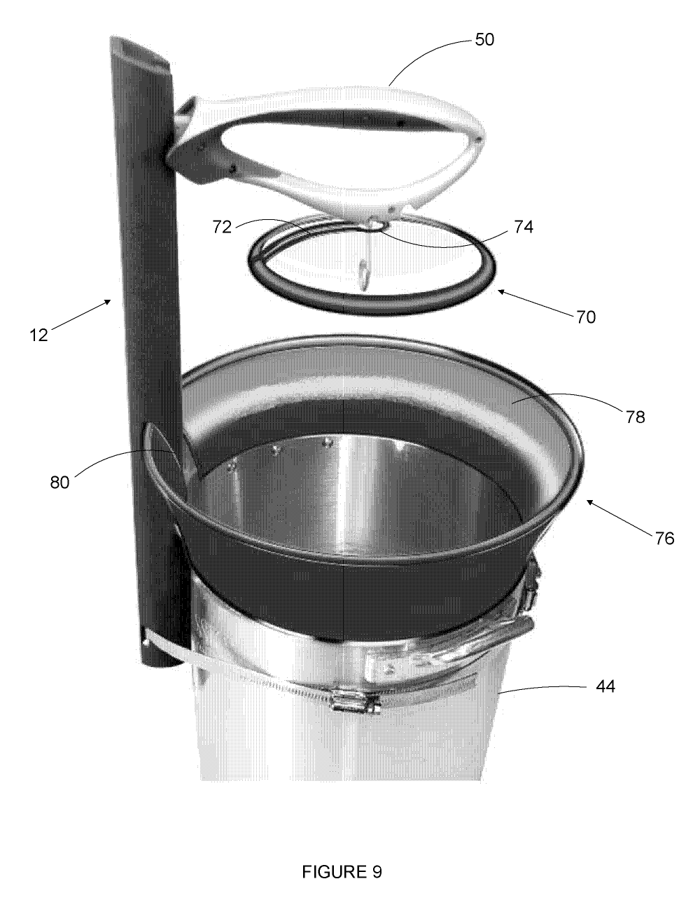

As shown in FIGS. 8 and 9, the support device 10 may also be provided with a splash guard. In one embodiment, the splash guard is a dome 64 that rests on the rim of the deep-fryer kettle to prevent any oil from splashing or splattering out. The dome 64 comprises two substantially domed portions connected together on a side by a hinge 66 so that the splash guard may be easily attached and removed. Additionally, the splash guard 64 has an opening 68 to accept the connecting member 62.

In another embodiment shown in FIG. 9, the splash guard is provided as a substantially circular disc 70 that hangs from the handle 50 to protect the user's hand from being burned by grease splatter. The disk 70 has an opening 72 to allow it to be attached and removed. The center 74 of the disk 70 may rest at the top of the rack 48 or at the top hook 62.

In yet another embodiment, the splash guard is provided as a collar 76 that is placed inside the deep-fryer kettle 44. The collar 76 is provided with a lip 78 that not only prevents grease from splattering and splashing outside of the kettle, but also prevents the oil it from overflowing during frying. To hold the collar in place, a groove (not shown) around the circumference of the collar 76 rests on the rim of the kettle 44. In addition, slit 80 accommodates the vertical support 12 and allows the collar 76 to flex to fit kettles of various sizes. Preferably, the dome 64, disk 70 and collar 76 splash guards are made from a heat resistant material.

Many other uses of the support device 10 are also contemplated by the present invention. Some exemplary applications include adjustable shelving, utility racks, garage and household storage and organization, lighting stands, hangers, and display devices. This list is not exhaustive or limiting. Depending on the particular application, the form of the body portion 50 will adapt as necessary. For example, the body portion may be provided as a hook (not shown) for hanging plants or kitchen items, or it may be provided as a bracket or flat surface (not shown) for supporting a shelf. The body portion 28 may also be provided so that it that can swivel or bend with respect to the head portion 30.

It is also contemplated that the support device may also be used with the support post oriented substantially horizontally. This configuration would allow the present invention to provide for side-to-side adjustment. In this embodiment, in the “locked” position, the rear surface of the head portion 30 will engage the rear surface of the internal channel 20, and the forward surface of the head portion will engage either the first forward surface of the internal channel 22 or the second forward surface of the internal channel 24. In this “locked” position, the head portion 26 is immovable inside the internal channel 18 and the arm 14 will be capable of supporting a load.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A support device comprising:
a support post having an internal channel; and
an arm slidable within said internal channel;
said arm shaped such that, gravitational bias of said arm under the influence of its own weight causes said arm to lock within the internal channel.

2. The support device of claim 1 wherein said arm is pivotable within the internal channel.

3. The support device of claim 2 wherein said arm is freely slidable within said internal channel when the arm is pivoted so that it is substantially perpendicular to the support post.

4. The support device of claim 2 wherein said arm locks within the internal channel when the arm is pivoted so that it is not substantially perpendicular to the support post.

5. The support device of claim 2 wherein:
the internal channel has a rear surface and at least one forward surface; and
the arm comprises a head portion having a rear surface and a forward surface, the head portion being shaped to be slidably received within the internal channel.

6. The support device of claim 5 wherein the rear surface and the forward surface of the head portion are arranged such that, when the arm is pivoted so that it is not substantially perpendicular to the support post, the rear surface of the head portion engages the rear surface of the internal channel and the forward surface of the head portion engages the at least one forward surface of the internal channel.

7. The support device of claim 5 wherein the at least one forward surface of the internal channel comprises a first forward surface and a second forward surface.

8. The support device according to claim 7 wherein the rear surface and the forward surface of the head portion are arranged such that, when the arm is pivoted so that it is not substantially perpendicular to the support post, the rear surface of the head portion engages the rear surface of the internal channel and the forward surface of the head portion engages the first forward surface and the second forward surface of the internal channel.

9. The support device of claim 6 further comprising:
a tooth located on the rear surface of said head portion; and
a plurality of grooves on the rear surface of said internal channel shaped to accept said tooth.

10. The support device of claim 6 wherein said arm further comprises a body portion positioned adjacent to said head portion.

11. The support device of claim 10 wherein said body portion comprises a handle.

12. The support device of claim 11 wherein said handle has a connecting member at an end remote from said support member.

13. The support device of claim 12 wherein said connecting member is a hook.

14. The support device of claim 6 wherein said support post further includes at least one notch shaped to accept the rim of a deep-fryer kettle.

15. The support device of claim 6 further comprising a strap and a latch for securing the support device around a deep-fryer kettle.

16. The support device of claim 15 wherein the strap is connected to the support post.

17. The support device of claim 6 wherein said support post further includes a stopping mechanism within the internal channel to prevent the head portion from advancing past.

18. The support device of claim 17 wherein said stopping mechanism is a pin.

19. The support device of claim 12, further comprising a splash guard.

20. The support device of claim 19 wherein said splash guard comprises a substantially circular member having an opening to accept said connecting member.

21. The support device of claim 19 wherein said splash guard comprises two substantially domed portions connected together on a side by a hinge and having an opening to accept said connecting member.

22. The support device of claim 19 wherein said splash guard comprises a substantially cone-shaped collar being open on a side.

23. A support device comprising:
a support post having an internal channel including a rear surface and at least one forward surface; and
an arm comprising a body portion and a head portion, said head portion having a rear surface and a forward surface and being shaped to be slidably received within the internal channel of the support post;
the rear surface and the forward surface of the head portion being arranged such that, gravitational bias of said arm under the influence of its own weight causes the rear surface of the head portion to engage the rear surface of the internal channel and the forward surface of the head portion to engage the at least one forward surface of the internal channel.

24. The support device of claim 23 wherein the at least one forward surface of said internal channel comprises a first forward surface and a second forward surface.

25. The support device of claim 24 wherein the rear surface and the forward surface of the head portion are arranged such that, gravitational bias of said arm under the influence of its own weight causes the rear surface of the head portion to engage the rear surface of the internal channel and the forward surface of the head portion to engage the first forward surface and the second forward surface of the internal channel.

26. The support device of claim 23 wherein said body portion comprises a handle.

27. The support device of claim 26 wherein said handle has a connecting member at an end remote from said support member.

28. The support device of claim 27 wherein said connecting member is a hook.

29. The support device of claim 23 wherein said support post further includes at least one notch shaped to accept the rim of a deep-fryer kettle.

30. The support device of claim 23 further comprising a strap and a latch for securing the support device around a deep-fryer kettle.

31. The support device of claim 30 wherein the strap is connected to the support post.

32. The support device of claim 23 wherein said support post further includes a stopping mechanism within the internal channel to prevent the head portion from advancing past.

33. The support device of claim 32 wherein said stopping mechanism is a pin.

34. The support device of claim 27, further comprising a splash guard.

35. The support device of claim 34 wherein said splash guard comprises a substantially circular member having an opening to accept said connecting member.

36. The support device of claim 34 wherein said splash guard comprises two substantially domed portions connected together on a side by a hinge and having an opening to accept said connecting member.

37. The support device of claim 34 wherein said splash guard comprises a substantially cone-shaped collar being open on a side.

38. A turkey deep-fryer comprising:
a support device comprising a support post having an internal channel and an arm slidable within the internal channel of the support post;
a kettle; and
a turkey mounting apparatus.

39. The turkey deep-fryer of claim 38 wherein said arm is shaped such that, gravitational bias of said arm under the influence of its own weight causes the arm to lock within the internal channel.

40. The turkey deep-fryer of claim 39 wherein said internal channel further comprises a rear surface and at least one forward surface and said arm further comprises a body portion and a head portion, the head portion having a rear surface and a forward surface.

41. The support device of claim 40 wherein the rear surface and the forward surface of the head portion are arranged such that, gravitational bias of said arm under the influence of its own weight causes the rear surface of the head portion to engage the rear surface of the internal channel and the forward surface of the head portion to engage the at least one forward surface of the internal channel.

42. The support device according to claim 40 wherein the internal channel comprises a first forward surface and a second forward surface.

43. The support device according to claim 42 wherein the rear surface and the forward surface of the head portion are arranged such that, gravitational bias of said arm under the influence of its own weight causes the rear surface of the head portion to engage the rear surface of the internal channel and the forward surface of the head portion to engage the first forward surface and the second forward surface of the internal channel.

44. The turkey deep-fryer of claim 38 wherein said turkey mounting apparatus comprises a rack.

45. The turkey deep-fryer of claim 38 wherein said turkey mounting apparatus comprises a basket.

46. The support device of claim 41 wherein said body portion comprises a handle.

47. The support device of claim 46 wherein said handle has a connecting member at an end remote from said support member for connecting the handle to the turkey mounting apparatus.

48. The support device of claim 47 wherein said connecting member is a hook.

49. The support device of claim 41 wherein said kettle further comprises a rim and the support post further includes at least one notch shaped to accept the rim.

50. The support device of claim 41 further comprising a strap and a latch for securing the support device around the kettle.

51. The support device of claim 50 wherein the strap is connected to the support post.

52. The support device of claim 41 wherein said support post further includes a stopping mechanism within the internal channel to prevent the head portion from advancing past.

53. The support device of claim 52 wherein said stopping mechanism is a pin.

54. The support device of claim 47, further comprising a splash guard.

55. The support device of claim 54 wherein said splash guard comprises a substantially circular member having an opening to accept said connecting member.

56. The support device of claim 54 wherein said splash guard comprises two substantially domed portions connected together on a side by a hinge and having an opening to accept said connecting member.

57. The support device of claim 54 wherein said splash guard comprises a substantially cone-shaped collar being open on a side.
